(19) United States
(12) Patent Application Publication
(10) Pub. No.: US 2009/0016638 A1
(43) Pub. Date: Jan. 15, 2009

(54) DEFECTIVE PIXEL DETECTOR, IMAGING DEVICE, AND DEFECTIVE PIXEL DETECTION METHOD

(76) Inventors: Hiroshi Nagatsuma, Nagoya (JP); Yasuo Masui, Nishikamo-gun (JP); Tadamasa Nakamura, Nagoya (JP); Katsuhiro Nishiwaki, Chita-gun (JP)

Correspondence Address: OSTROLENK FABER GERB & SOFFEN, 1180 AVENUE OF THE AMERICAS, NEW YORK, NY, 100368403, US

(21) Appl. No.: 12/166,859

(22) Filed: Jul. 2, 2008

(30) Foreign Application Priority Data
Jul. 9, 2007 (JP) 2007-179890

(51) Int. Cl. G06K 9/40

(52) U.S. Cl. 382/275

(57) ABSTRACT

In a defective pixel detector 20 mounted on an imaging device 100, a pixel data acquisition module 20a successively obtains pixel data of a target pixel set as an object of defective pixel detection and pixel data of plural surrounding pixels located in a neighborhood of the target pixel. A first operation module 20b calculates absolute values of differences between pixel data of multiple specific peripheral pixels selected among the plural surrounding pixels, as first absolute values. A defective pixel criterion setting module 20c sets a defective pixel criterion, based on differences between the multiple first absolute values and a preset threshold value. A second operation module 20d calculates absolute values of differences between the pixel data of the target pixel and the pixel data the multiple specific peripheral pixels, as second absolute values. A defective pixel identification module 20e identifies whether the target pixel is a defective pixel, based on the multiple second absolute values and the set defective pixel criterion. This arrangement enables successive and accurate detection of defective pixels in the imaging process.

### BACKGROUND OF THE INVENTION

1. Field of the Invention

The present invention relates to a defective pixel detector mounted on an imaging device, and more specifically pertains to a technique of detecting defective pixels caused by, for example, malfunction of an image sensor included in the imaging device, among multiple pixels constituting an image taken by the imaging device.

2. Description of the Related Art

Various imaging devices including digital still cameras and digital video cameras have become popular and been widely used. The imaging device is equipped with an image sensor designed to convert light received via lenses into electrical signals. A CCD (charge coupled device) sensor and a CMOS (complementary metal oxide semiconductor) sensor are typical examples adopted for the image sensor. The image sensor includes multiple light receiving elements (photodiodes) provided corresponding to multiple pixels constituting a taken image and arranged to respectively output pixel data representing pixel values of the corresponding pixels. In display of an image taken with the imaging device on a display device, malfunction of any light receiving element in the imaging process may cause output of pixel data having a higher pixel value than an originally expected pixel value. Such output causes a pixel corresponding to the malfunctioning light receiving element to be recognized as a white defect. Malfunction of any light receiving element in the imaging process may otherwise cause output of pixel data having a lower pixel value than the originally expected pixel value. Such output causes a pixel corresponding to the malfunctioning light receiving element to be recognized as a black defect.

Various techniques have been proposed for the imaging device to detect any defective pixel caused by malfunction of the image sensor among multiple pixels constituting a taken image and to correct pixel data representing a pixel value of the detected defective pixel. A prior art technique disclosed in Japanese Patent Laid-Open No. 2001-86517 is applicable to, for example, detect a white defect as a defective pixel in a single plate color video camera. This prior art technique checks the absence of a high-frequency component in a target pixel set as a processing object based on the frequency characteristics of peripheral pixels with different color filters from the color filter set on the target pixel, and identifies the target pixel as a defective pixel in response to subsequent detection of the presence of the high frequency component in the target pixel. Another prior art technique disclosed in Japanese Patent Laid-Open No. 2002-344814 successively stores 3×3 pixel blocks respectively including target pixels on their centers into a buffer in the imaging process, and compares the pixel value of the target pixel with the pixel value of each of multiple peripheral pixels. This prior art technique then counts a number Hn of peripheral pixels having the larger pixel values than the pixel value of the target pixel and a number Ln of peripheral pixels having the smaller pixel values than the pixel value of the target pixel. When the counted number Hn of the peripheral pixels having the larger pixel values than the pixel value of the target pixel is equal to or greater than a value ‘5’, the target pixel is identified as a black defect. The pixel value of the target pixel is then replaced by an average of the peripheral pixels having the larger pixel values and is output as a corrected pixel value. When the counted number Ln of the peripheral pixels having the smaller pixel values than the pixel value of the target pixel is equal to or greater than a value ‘5’, on the other hand, the target pixel is identified as a white defect. The pixel value of the target pixel is then replaced by an average of the peripheral pixels having the smaller pixel values and is output as a corrected pixel value.

The proposed prior art techniques of Japanese Patent Laid-Open No. 2001-86517 and No. 2002-344814 are, however, not sufficient for accurate detection of defective pixels. There is still room for further improvement.

### SUMMARY OF THE INVENTION

In a defective pixel detector mounted on an imaging device using an image sensor, there would thus be a demand for successive and accurate detection of defective pixels in the imaging process.

The present invention accomplishes at least part of the demands mentioned above by the following configurations applied to the defective pixel detector, the imaging device, and the defective pixel detection method.

According to one aspect, the present invention is directed to a defective pixel detector mounted on an imaging device and constructed to detect a defective pixel among multiple pixels constituting an image taken with the imaging device. The defective pixel detector includes: a pixel data acquisition module configured to successively obtain pixel data representing a pixel value of a target pixel set as an object of defective pixel detection and pixel data representing pixel values of plural surrounding peripheral pixels located in a neighborhood of the target pixel; a first operation module configured to calculate absolute values of differences between pixel values of multiple specific peripheral pixels selected among the plural surrounding pixels, as first absolute values; a defective pixel criterion setting module configured to set a defective pixel criterion, which is used in subsequent identification of whether the target pixel is a defective pixel, based on differences between the multiple first absolute values and a preset threshold value; a second operation module configured to calculate absolute values of differences between the pixel value of the target pixel and the pixel values of the multiple specific peripheral pixels, as second absolute values; and a defective pixel identification module configured to identify whether the target pixel is a defective pixel, based on the multiple second absolute values and the set defective pixel criterion.

The inventors of the present application have noted that pixel data of peripheral pixels located in the neighborhood of a target pixel set as the object of defective pixel detection affect the potential for recognition of the target pixel as a defective pixel. In the case of relatively close pixel values of the peripheral pixels, the target pixel is likely to be recognized as a defective pixel even when the pixel value of the target pixel has relatively small differences from the pixel values of the peripheral pixels. In the case of relatively discrete pixel values of the peripheral pixels, on the other hand, the target pixel is unlikely to be recognized as a defective pixel even when the pixel value of the target pixel has relatively large differences from the pixel values of the peripheral pixels. Such finding is true, irrespective of whether the defective pixel is a white defect or a black defect.

The defective pixel detector according to one aspect of the invention successively obtains the pixel data representing the pixel value of the target pixel set as the object of defective pixel detection and the pixel data representing the pixel values of the plural surrounding peripheral pixels located in the neighborhood of the target pixel. The number of pixel data obtained may be set arbitrarily. For example, in a matrix arrangement of multiple light receiving elements included in an image sensor mounted on the imaging device, the defective pixel detector may successively obtain pixel data of each 5×5 pixel block including a target pixel on its center. The defective pixel detector subsequently calculates the absolute values of the differences between the pixel values of the multiple specific peripheral pixels selected among the plural surrounding pixels as the first absolute values, and sets the defective pixel criterion, which is used in subsequent identification of whether the target pixel is a defective pixel, based on the differences between the multiple first absolute values and the preset threshold value. The multiple specific peripheral pixels and the preset threshold value may be set arbitrarily according to the arrangement of the light receiving elements in the image sensor and according to the presence or the absence of color filters set on the respective light receiving elements. This enables the defective pixel criterion to be set adequately according to the potential for recognition of the target pixel as a defective pixel. The defective pixel detector then calculates the absolute values of the differences between the pixel value of the target pixel and the pixel values of the multiple specific peripheral pixels as the second absolute values, and identifies whether the target pixel is a defective pixel, based on the multiple second absolute values and the set defective pixel criterion. The defective pixel detector of this arrangement mounted on the imaging device equipped with the image sensor determines whether each of the target pixels has a high potential for recognition as a defective pixel or a low potential for recognition as a defective pixel in the imaging process and successively and accurately identifies whether each of the target pixels is a defective pixel, based on the results of the determination.

A CCD and a CMOS sensor are typical examples adopted for the image sensor. In the image sensor, the light receiving elements may be arrayed in a matrix or may be arrayed in a honeycomb structure.

In one preferable application of the defective pixel detector according to the above aspect of the invention, the defective pixel criterion setting module sets the defective pixel criterion to a first defective pixel criterion when the multiple first absolute values are respectively not less than the preset threshold value, while setting the defective pixel criterion to a second defective pixel criterion, which is smaller than the first defective pixel criterion, when the multiple first absolute values are respectively less than the preset threshold value.

In the defective pixel detector of this application, when the multiple first absolute values are respectively not less than the preset threshold value, that is, in the case of relatively discrete pixel values of the multiple specific peripheral pixels, the defective pixel criterion setting module determines that the target pixel has a low potential for recognition as a defective pixel and sets the defective pixel criterion to the first defective pixel criterion. When the multiple first absolute values are respectively less than the preset threshold value, that is, in the case of relatively close pixel values of the multiple specific peripheral pixels, on the other hand, the defective pixel criterion setting module determines that the target pixel has a high potential for recognition as a defective pixel and sets the defective pixel criterion to the second defective pixel criterion, which is smaller than the first defective pixel criterion. In the defective pixel detector of this application, the defective pixel criterion setting module sets the stricter criterion of identifying the target pixel as a defective pixel for the target pixel likely to be recognized as a defective pixel than the criterion for the target pixel unlikely to be recognized as a defective pixel. This arrangement enables the stricter and thereby accurate identification of the target pixel as a defective pixel when the target pixel has a high potential for recognition as a defective pixel.

In one concrete procedure of this application, the defective pixel criterion setting module may set the defective pixel criterion to the first defective pixel criterion when at least one of the multiple first absolute values is not less than the preset threshold value, while setting the defective pixel criterion to the second defective pixel criterion when all the multiple first absolute values are less than the preset threshold value. In another concrete procedure of this application, the defective pixel criterion setting module may set the defective pixel criterion to the first defective pixel criterion when all the multiple first absolute values are not less than the preset threshold value, while setting the defective pixel criterion to the second defective pixel criterion when at least one of the multiple first absolute values is less than the preset threshold value.

In the defective pixel detector of this application, it is preferable that the defective pixel criterion setting module sets at least one of the first defective pixel criterion and the second defective pixel criterion, based on the pixel values of the multiple specific peripheral pixels.

The larger pixel values of the multiple specific peripheral pixels representing the higher luminance increase the potential for recognition of the target pixel as a black defect. The smaller pixel values of the multiple specific peripheral pixels representing the lower luminance increase the potential for recognition of the target pixel as a white defect. In other words, the larger pixel values of the multiple specific peripheral pixels representing the higher luminance decrease the potential for recognition of the target pixel as a white defect. The smaller pixel values of the multiple specific peripheral pixels representing the lower luminance decrease the potential for recognition of the target pixel as a black defect.

In the defective pixel detector of this arrangement, the defective pixel criterion setting module sets at least one of the first defective pixel criterion and the second defective pixel criterion, based on the pixel values of the multiple specific peripheral pixels. The defective pixel identification module can thus strictly identify whether the target pixel is a defective pixel.

One concrete procedure of this arrangement sets at least one of the first defective pixel criterion and the second defective pixel criterion, based on a simple average or a weighted average of the pixel values of the multiple specific peripheral pixels. In this case, there may be a linear or non-linear relation between the defective pixel criterion and the simple average or the weighted average of the pixel values of the multiple specific peripheral pixels.

In another preferable application of the defective pixel detector according to the above aspect of the invention, the defective pixel identification module identifies the target pixel as a defective pixel when the multiple second absolute values are respectively greater than the defective pixel criterion.

In the defective pixel detector of this application, the defective pixel identification module can readily identify the target pixel as a defective pixel or as a non-defective pixel. In one concrete procedure of this application, the defective pixel identification module identifies the target pixel as a defective pixel when at least one of the multiple second absolute values is greater than the defective pixel criterion. In another concrete procedure of this application, the defective pixel identification module identifies the target pixel as a defective pixel when all the multiple second absolute values are greater than the defective pixel criterion.

In one preferable embodiment of the defective pixel detector of the invention, the imaging device is equipped with an image sensor including multiple light receiving elements provided corresponding to the multiple pixels and arranged to respectively output pixel data representing pixel values of the corresponding pixels. Multiple different types of color filters designed to transmit different color lights are set in a predetermined arrangement on the multiple light receiving elements. The multiple specific peripheral pixels correspond to specific light receiving elements having a selected type of color filters identical with a color filter set on a light receiving element corresponding to the target pixel.

In the defective pixel detector of this embodiment having the multiple different types of color filters designed to transmit different color lights and set in the predetermined arrangement on the multiple light receiving elements, the defective pixel identification module enables stricter and thereby accurate identification of the target pixel as a defective pixel or a non-defective pixel.

In the defective pixel detector of the above embodiment, the preset threshold value may be set for each of the multiple different types of color filters.

In the defective pixel detector of the embodiment having the multiple different types of color filters designed to transmit different color lights and set in the predetermined arrangement on the multiple light receiving elements, the defective pixel identification module enables stricter and thereby accurate identification of the target pixel as a defective pixel or a non-defective pixel according to the type of the color filter.

In the defective pixel detector of the above embodiment, the defective pixel criterion may be set for each of the multiple different types of color filters.

In the defective pixel detector of the embodiment having the multiple different types of color filters designed to transmit different color lights and set in the predetermined arrangement on the multiple light receiving elements, the defective pixel identification module enables stricter and thereby accurate identification of the target pixel as a defective pixel or a non-defective pixel according to the type of the color filter.

According to another aspect, the invention is directed to an imaging device including: an imaging assembly equipped with an image sensor including multiple light receiving elements provided corresponding to multiple pixels constituting a taken image and arranged to respectively output pixel data representing pixel values of the corresponding pixels; a defective pixel detector configured to detect a defective pixel among the multiple pixels, based on the pixel data respectively output from the multiple light receiving elements; and a pixel data correction unit configured to correct pixel data representing a pixel value of the detected defective pixel. The defective pixel detector included in this imaging device may be configured to have any of the arrangements described above.

When the image taken with the imaging device has defective pixels, the imaging device of this arrangement successively and accurately detects the defective pixels in the imaging process and adequately corrects the pixel data of the detected defective pixels.

In one preferable application of the imaging device according to the above aspect of the invention, the pixel data correction unit replaces the pixel data of the detected defective pixel by an average of the pixel values of the multiple specific peripheral pixels.

In the imaging device of this application, the pixel data correction unit readily corrects the pixel data of the detected defective pixel. The correction of the pixel data of the defective pixel may replace the pixel data of the defective pixel by a weighted average of the pixel values of the multiple specific peripheral pixels, instead of the simple average of the pixel values of the multiple specific peripheral pixels.

The present invention is not restricted to the defective pixel detector or the imaging device described above, but may be actualized by diversity of other applications, for example, a defective pixel detection method, a computer program for actualizing any of the defective pixel detector, the imaging device, and the defective pixel detection method, a recording medium in which such a computer program is recorded, and a data signal configured to include such a computer program and embodied in a carrier wave. Any of the various additional arrangements explained above may be adopted for any of these applications.

In the applications of the invention as the computer program and the recording medium in which the computer program is recorded, the invention may be given as a whole program to control the operations of the defective pixel detector or the imaging device or as a partial program to exert only the characteristic functions of the invention. Available examples of the recording medium include flexible disks, CD-ROMs, DVD-ROMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 schematically illustrates the structure of an imaging device in a first embodiment of the invention;

FIG. 2 shows an array of light receiving elements in an image sensor included in an imaging assembly of the imaging device;

FIG. 3 is an explanatory view schematically showing the outline of a defective pixel detection process and a pixel data correction process performed in the first embodiment;

FIG. 4 is a flowchart showing the details of the defective pixel detection process and the pixel data correction process in the first embodiment;

FIG. 5 is a flowchart showing the details of the defective pixel detection process and the pixel data correction process in the first embodiment;

FIG. 6 is a flowchart showing the details of the defective pixel detection process and the pixel data correction process in the first embodiment;

FIG. 7 is a flowchart showing the details of the defective pixel detection process and the pixel data correction process in the first embodiment;

FIGS. 8(a) through (c) schematically show arrangements of pixels in a 5×5 pixel block;

FIG. 9 schematically illustrates the structure of another imaging device in a second embodiment of the invention;

FIG. 10 is a flowchart showing a defective pixel detection process and a pixel data correction process performed in the second embodiment; and

FIG. 11 schematically shows an arrangement of pixels in a 3×3 pixel block.

### DESCRIPTION OF THE PREFERRED EMBODIMENTS

Some modes of carrying out the invention are described below in the following sequence as preferred embodiments with reference to the accompanied drawings:

### A. First Embodiment

A1. Structure of Imaging Device

A2. Defective Pixel Detection Process and Pixel Data Correction Process
A2.1. Red (R) Target Pixel
A2.2. Green (G) Target Pixel
A2.3. Blue (B) Target Pixel

### B. Second Embodiment

B1. Structure of Imaging Device
B2. Defective Pixel Detection Process and Pixel Data Correction Process

### C. Other Aspects

### A. First Embodiment

### A1. Structure of Imaging Device

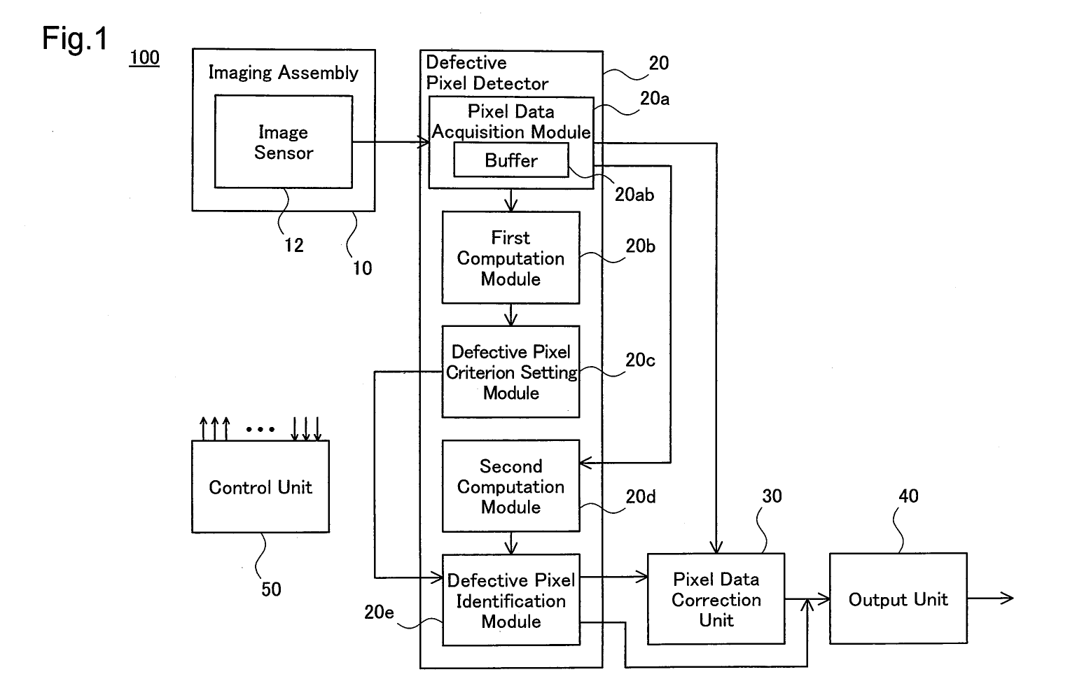

FIG. 1 schematically illustrates the structure of an imaging device 100 in a first embodiment of the invention. The imaging device 100 includes an imaging assembly 10, a defective pixel detector 20, a pixel data correction unit 30, and an output unit 40. The imaging device 100 successively detects defective pixels (white defects and black defects) among multiple pixels constituting an image taken with the imaging assembly 10, corrects pixel data of the detected defective pixels, and outputs the corrected pixel data as explained below. The defective pixel detector 20, the pixel data correction unit 30, and the output unit 40 are configured by the hardware in this embodiment, although some part of these constituents may be implemented by the software configuration. The imaging device 100 also includes a display unit constructed to display the taken image, for example, a liquid crystal panel, and a recorder unit constructed to store the taken image as pixel data in a recording medium, such as a flash memory, although not being specifically illustrated. The imaging device 100 further has a control unit 50 configured to include a CPU, a RAM, and a ROM and control the respective constituents of the imaging device 100.

The imaging assembly 10 has a zoom lens, a focusing lens, and an aperture mechanism (not shown), as well as an image sensor 12 arranged to convert the light received via these elements into electrical signals. The image sensor 12 adopted in this embodiment is a CMOS sensor and includes multiple light receiving elements (photodiodes) provided corresponding to the multiple pixels constituting the taken image to output pixel data representing pixel values of the respectively corresponding pixels.

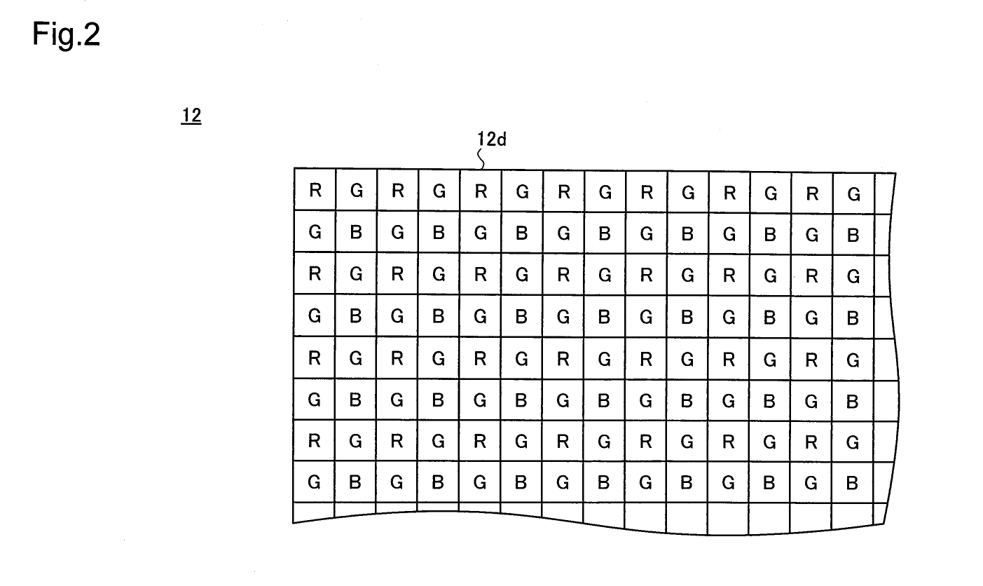

FIG. 2 shows an array of light receiving elements 12d in the image sensor 12. The imaging device 100 of the embodiment has the imaging assembly 10 of a single-plate type including only one image sensor 12. The image sensor 12 of this embodiment has multiple light receiving elements 12d arrayed in a matrix. The multiple light receiving elements 12d in the image sensor 12 may otherwise be arrayed in a honeycomb structure. Each of the light receiving elements 12d has one color filter. In the structure of this embodiment, the respective light receiving elements 12d have color filters of three primary colors, red (R), green (G), and blue (B) arrayed as shown in FIG. 2. In another example, the respective light receiving elements 12d may have color filters of three complementary colors, cyan, magenta, and yellow in a preset arrangement. The number of the light receiving elements 12d included in the image sensor 12 is determined arbitrarily corresponding to an optical resolution demand.

In the imaging device 100 of FIG. 1, the defective pixel detector 20 includes a pixel data acquisition module 20a, a first computation module 20b, a defective pixel criterion setting module 20c, a second computation module 20d, and a defective pixel identification module 20e. The defective pixel detector 20 functions to detect defective pixels among multiple pixels constituting an image taken with the imaging assembly 10. The pixel data acquisition module 20a has a buffer 20ab. The defective pixel detector 20 corresponds to the defective pixel detector of the invention. The following describes the functions of the respective constituents of the defective pixel detector 20, a defective pixel detection process, and a pixel data correction process performed by the pixel data correction unit 30.

### A2. Defective Pixel Detection Process and Pixel Data Correction Process

The description sequentially regards the outline and the details of the defective pixel detection process and the pixel data correction process.

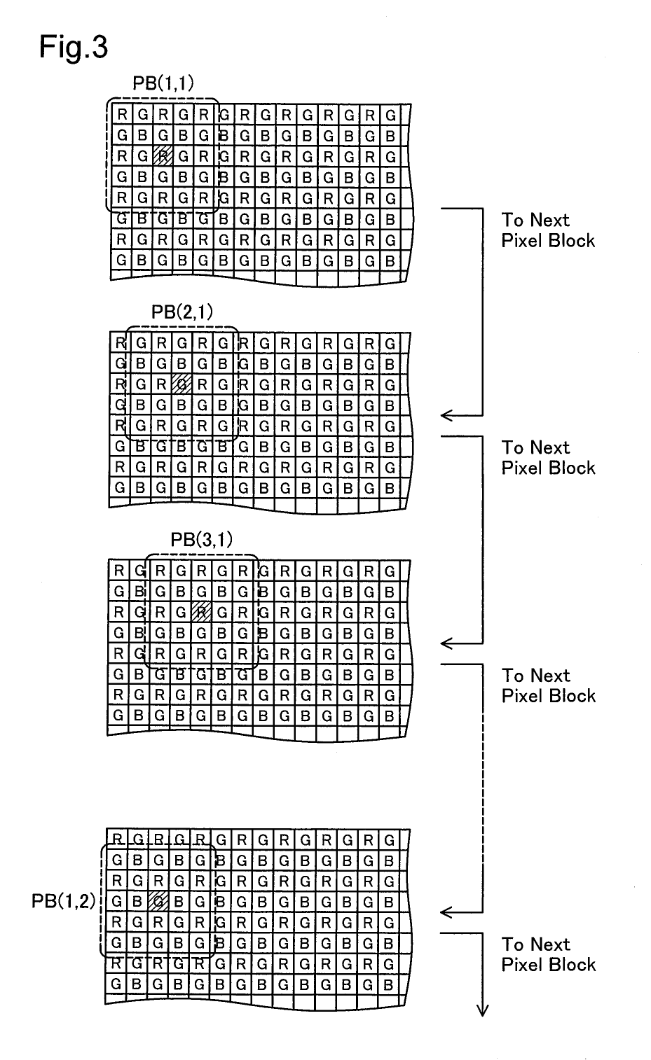

FIG. 3 is an explanatory view schematically showing the outline of the defective pixel detection process and the pixel data correction process performed in the first embodiment. In the procedure of this embodiment, a first step (1) obtains pixel data of each 5×5 pixel block PB(i,j) as a current processing object encircled by the broken line, out of multiple pixels constituting a taken image. In the pixel block PB(i,j), ‘i’ and ‘j’ respectively represent an i-th pixel block rightward from an upper left end of the image and a j-th pixel block downward from the upper left end of the image. A second step (2) determines whether a hatched target pixel as an object of defective pixel detection located on the center of the object pixel block PB(i,j) has a high potential for recognition as a defective pixel, based on pixel values of peripheral pixels located in the neighborhood of the target pixel. A third step (3) sets a criterion for identification of the target pixel as a defective pixel according to the result of the determination. A fourth step (4) identifies whether the target pixel is a defective pixel, based on the set criterion. A fifth step (5) corrects the pixel value of the target pixel, when the target pixel is identified as a defective pixel. This series of processing is repeatedly executed with a shift of the object pixel block in a sequence of a pixel block PB(1,1), a pixel block PB(2,1), a pixel block PB(3,1) . . . , a pixel block PB(1,2) . . . , to a last pixel block including a last target pixel as shown in FIG. 3.

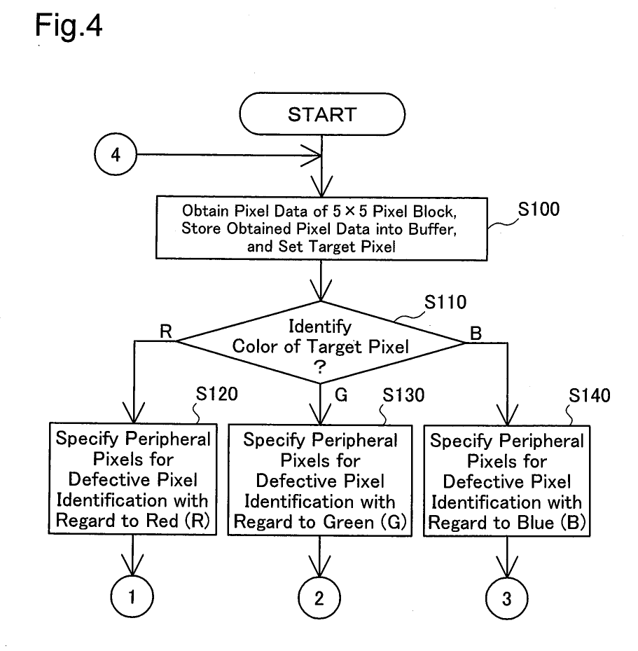

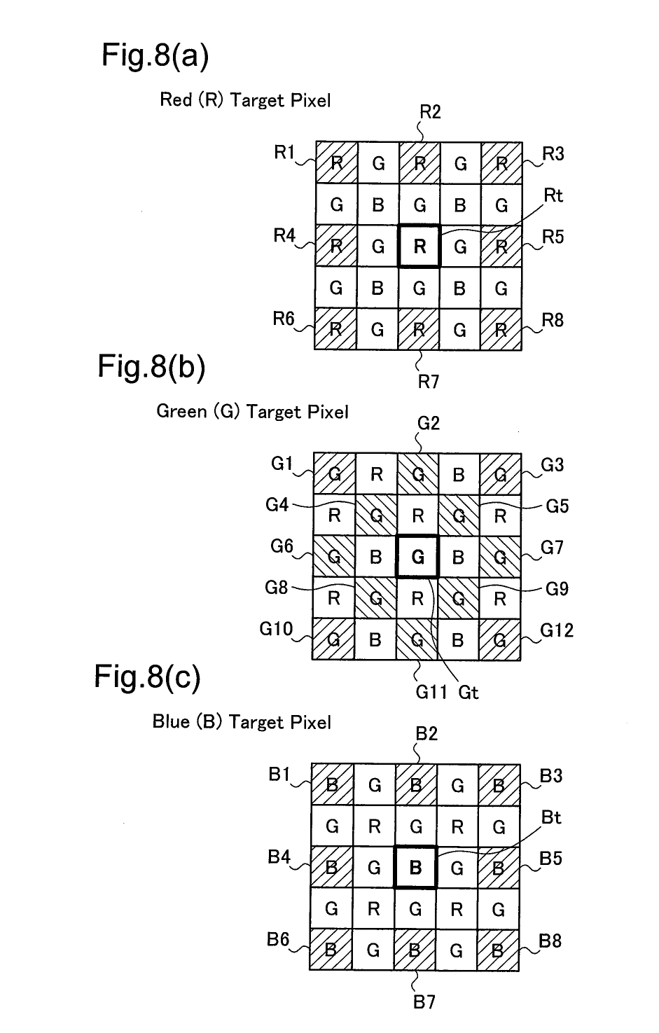

FIGS. 4 through 7 are flowcharts showing the details of the defective pixel detection process and the pixel data correction process in the first embodiment. FIGS. 8(a) through (c) schematically show arrangements of pixels in the 5×5 pixel block. FIGS. 8(a), 8(b), and 8(c) respectively show arrangements of pixels in the 5×5 pixel block with regard to the red (R) target pixel, the green (G) target pixel, and the blue (B) target pixel. In the respective arrangements of the 5×5 pixel block shown in FIGS. 8(a) through 8(c), a pixel located on the center of the pixel block and encircled by the thick line represents a target pixel as an object of defective pixel detection. Among surrounding pixels located in the neighborhood of the target pixel, hatched pixels represent peripheral pixels for defective pixel identification as explained later.

Referring to the flowchart of FIG. 4, the pixel data acquisition module 20a first obtains analog pixel data of each 5×5 pixel block as a current processing object out of analog pixel data output from the respective light receiving elements 12d of the image sensor 12, performs analog-to-digital (A-D) conversion of the obtained analog pixel data, stores the A-D converted pixel data as pixel values of the respective pixels in the object pixel block into the buffer 20ab, and sets a center pixel located on the center of the object pixel block as a target pixel (step S100). The pixel data acquisition module 20a subsequently identifies the color of the set target pixel or the color of the color filter set on a specific light receiving element 12d corresponding to the target pixel among red (R), green (G), and blue (B) (step S110). In the image sensor 12, the array of the color filters respectively set on the multiple light receiving elements 12d is determined in advance. The color of the target pixel is thus readily identifiable by counting the number of object pixel blocks from the start of the processing.

The pixel data acquisition module 20a selects pixels corresponding to the light receiving elements 12d having the same color filter (the same color) as the color filter (color) of the specific light receiving element 12d corresponding to the target pixel, among surrounding pixels located in the neighborhood of the target pixel and specifies the selected pixels as peripheral pixels for defective pixel identification used for identification of the target pixel as a defective pixel. Upon identification of the color of the target pixel as red (R) at step S110, the pixel data acquisition module 20a specifies surrounding pixels R1 to R8 as peripheral pixels for defective pixel identification as shown in FIG. 8(a) (step S120). Upon identification of the color of the target pixel as green (G) at step S110, the pixel data acquisition module 20a specifies surrounding pixels G1 to G12 as peripheral pixels for defective pixel identification as shown in FIG. 8(b) (step S130). Upon identification of the color of the target pixel as blue (B) at step S110, the pixel data acquisition module 20a specifies surrounding pixels B1 to B8 as peripheral pixels for defective pixel identification as shown in FIG. 8(c) (step S140). In this embodiment, all the hatched surrounding pixels are specified as the peripheral pixels for defective pixel identification. The peripheral pixels for defective pixel identification may, however, be specified arbitrarily according to the array of the light receiving elements 12d in the image sensor 12 and according to the array of the color filters set on the respective light receiving elements 12d.

### A2.1. Red (R) Target Pixel

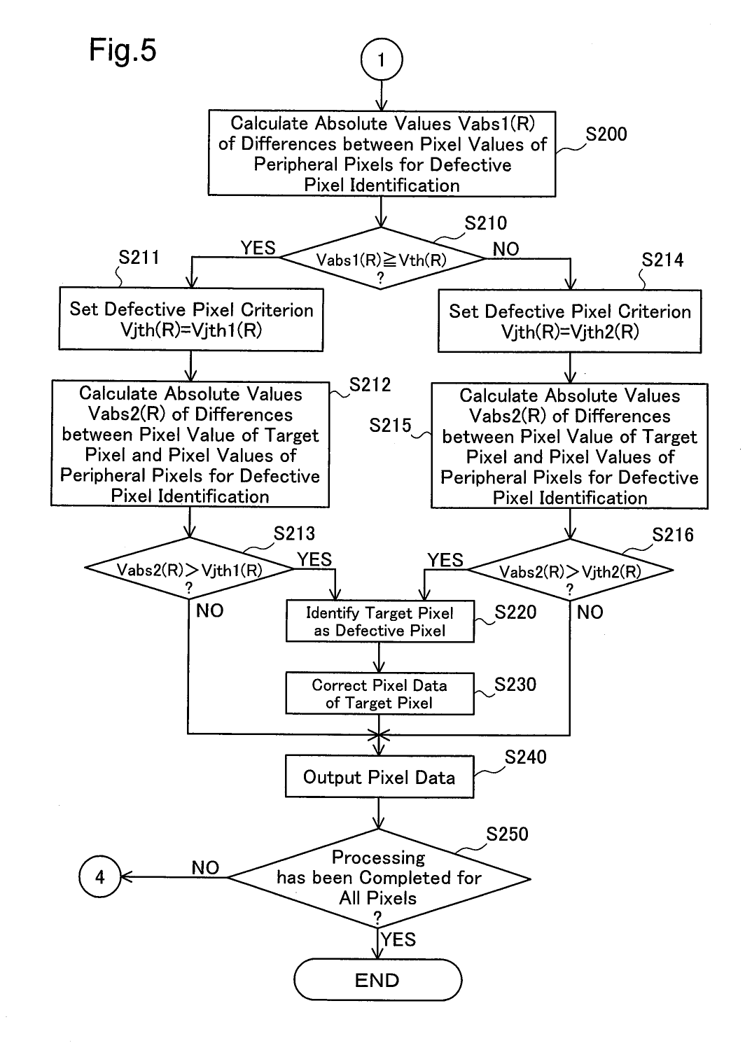

Upon identification of the color of the target pixel as red (R) at step S110 in the flowchart of FIG. 4, the processing flow proceeds to the flowchart of FIG. 5 after the specification of the peripheral pixels for defective pixel identification at step S120. The first computation module 20b calculates absolute values Vabs1(R) of respective differences between the pixel values of the peripheral pixels R1 to R8 for defective pixel identification specified with regard to the red (R) target pixel Rt as shown in FIG. 8(a) (step S200). The absolute values Vabs1(R) are used for subsequent determination of whether the target pixel Rt has a high potential for recognition as a defective pixel and are referred to by the defective pixel criterion setting module 20c to set a defective pixel criterion Vjth(R) for the red (R) target pixel Rt as explained later. The absolute values Vabs1(R) correspond to the first absolute values of the invention.

In this embodiment, the absolute values Vabs1(R) of the differences calculated by the first computation module 20b include the absolute value of the difference between the pixel values of the peripheral pixels R1 and R2 for defective pixel identification, the absolute value of the difference between the pixel values of the peripheral pixels R2 and R3 for defective pixel identification, the absolute value of the difference between the pixel values of the peripheral pixels R3 and R5 for defective pixel identification, the absolute value of the difference between the pixel values of the peripheral pixels R5 and R8 for defective pixel identification, the absolute value of the difference between the pixel values of the peripheral pixels R8 and R7 for defective pixel identification, the absolute value of the difference between the pixel values of the peripheral pixels R7 and R6 for defective pixel identification, the absolute value of the difference between the pixel values of the peripheral pixels R6 and R4 for defective pixel identification, the absolute value of the difference between the pixel values of the peripheral pixels R4 and R5 for defective pixel identification, and the absolute value of the difference between the pixel values of the peripheral pixels R2 and R7 for defective pixel identification (see FIG. 8(a)).

The defective pixel criterion setting module 20c determines whether at least one of the multiple calculated absolute values Vabs1(R) is not less than a threshold value Vth(R) of the red (R) target pixel Rt (step S210). This determines whether the target pixel Rt has a high potential for recognition as a defective pixel. When at least one of the multiple absolute values Vabs1(R) is not less than the threshold value Vth(R), it is determined that the target pixel Rt has a low potential for recognition as a defective pixel. When all the multiple absolute values Vabs1(R) are less than the threshold value Vth(R), on the other hand, it is determined that the target pixel Rt has a high potential for recognition as a defective pixel. Such determination is based on the findings that relatively discrete pixel values of the peripheral pixels for defective pixel identification make the target pixel unlikely to be recognized as a defective pixel and that relatively close pixel values of the peripheral pixels for defective pixel identification make the target pixel likely to be recognized as a defective pixel. The threshold value Vth(R) corresponds to the preset threshold value of the invention.

When at least one of the multiple absolute values Vabs1(R) is not less than the threshold value Vth(R) (step S210: Yes), the defective pixel criterion setting module 20c sets a defective pixel criterion Vjth(R) for the red (R) target pixel Rt, which will be used in a later step by the defective pixel identification module 20e, to a preset threshold value Vjth1(R) (Vjth(R)=Vjth1(R)) (step S211). The threshold value Vjth1(R) corresponds to the first defective pixel criterion of the invention.

The second computation module 20d subsequently calculates absolute values Vabs2(R) of differences between the pixel value of the target pixel Rt and the pixel values of the peripheral pixels R1 to R8 for defective pixel identification specified with regard to the target pixel Rt (step S212). The absolute values Vabs2(R) are used for subsequent identification of whether the target pixel Rt is a defective pixel by the defective pixel identification module 20e as explained later. The absolute values Vabs2(R) correspond to the second absolute values of the invention.

The defective pixel identification module 20e then determines whether all the multiple calculated absolute values Vabs2(R) are greater than the threshold value Vjth1(R) (step S213). When all the multiple absolute values Vabs2(R) are greater than the threshold value Vjth1(R) (step S213: Yes), the defective pixel identification module 20e identifies the target pixel Rt as a defective pixel (step S220).

The pixel data correction unit 30 then corrects the pixel data of the target pixel Rt (step S230). According to the concrete procedure of this embodiment, the pixel data correction unit 30 obtains the pixel values of the peripheral pixels R1 to R8 for defective pixel identification specified with regard to the target pixel Rt from the buffer 20ab, calculates an average of the obtained pixel values, and replaces the pixel value of the target pixel Rt by the calculated average to correct the pixel data of the pixel value Rt. The output unit 40 outputs the corrected pixel data (step S240).

When at least one of the multiple absolute values Vabs2(R) is not greater than the threshold value Vjth1(R) (step S213: No), on the other hand, the defective pixel identification module 20e identifies the target pixel Rt as no defective pixel. Without any correction of the pixel data of the target pixel Rt by the pixel data correction unit 30, the output unit 40 outputs the pixel data (step S240).

Upon completion of the processing and the output of pixel data with regard to all the pixels (step S250: yes), the processing flow terminates the defective pixel detection process and the pixel data correction process. Upon no completion of the processing and the output of pixel data with regard to all the pixels (step S250: No), on the other hand, the processing flow goes back to step S100 in the flowchart of FIG. 4 to detect a defective pixel with regard to a target pixel of a next object pixel block.

When all the multiple absolute values Vabs1(R) are less than the threshold value Vth(R) (step S210: No), the defective pixel criterion setting module 20c sets the defective pixel criterion Vjth(R) for the red (R) target pixel Rt, which will be used in a later step by the defective pixel identification module 20e, to a preset threshold value Vjth2(R) (Vjth(R)=Vjth2(R)) (step S214). The threshold value Vjth2(R) is smaller than the threshold value Vjth1(R). This sets the stricter criterion for identification of the target pixel Rt as a defective pixel, since the determination result of step S210 that all the multiple absolute values Vabs1(R) are less than the threshold value Vth(R) suggests that the target pixel Rt has a high potential for recognition as a defective pixel. The threshold value Vjth2(R) corresponds to the second defective pixel criterion of the invention.

In the same manner as the calculation at step S212, the second computation module 20d calculates the absolute values Vabs2(R) of the differences between the pixel value of the target pixel Rt and the pixel values of the peripheral pixels R1 to R8 for defective pixel identification specified with regard to the target pixel Rt (step S215).

The defective pixel identification module 20e then determines whether all the multiple calculated absolute values Vabs2(R) are greater than the threshold value Vjth2(R) (step S216). When all the multiple absolute values Vabs2(R) are greater than the threshold value Vjth2(R) (step S216: Yes), the defective pixel identification module 20e identifies the target pixel Rt as a defective pixel (step S220).

The pixel data correction unit 30 then corrects the pixel data of the target pixel Rt according to the procedure described above (step S230), and the output unit 40 outputs the corrected pixel data (step S240).

When at least one of the multiple absolute values Vabs2(R) is not greater than the threshold value Vjth2(R) (step S216: No), on the other hand, the defective pixel identification module 20e identifies the target pixel Rt as no defective pixel. Without any correction of the pixel data of the target pixel Rt by the pixel data correction unit 30, the output unit 40 outputs the pixel data (step S240).

Upon completion of the processing and the output of pixel data with regard to all the pixels (step S250: yes), the processing flow terminates the defective pixel detection process and the pixel data correction process. Upon no completion of the processing and the output of pixel data with regard to all the pixels (step S250: No), on the other hand, the processing flow goes back to step S100 in the flowchart of FIG. 4 to detect a defective pixel with regard to a target pixel of a next object pixel block.

The defective pixel detection process and the pixel data correction process for the red (R) target pixel Rt described above with reference to the flowchart of FIG. 5 are similarly performed for the green (G) target pixel Gt and the blue (B) target pixel Bt as explained below.

### A2.2. Green (G) Target Pixel

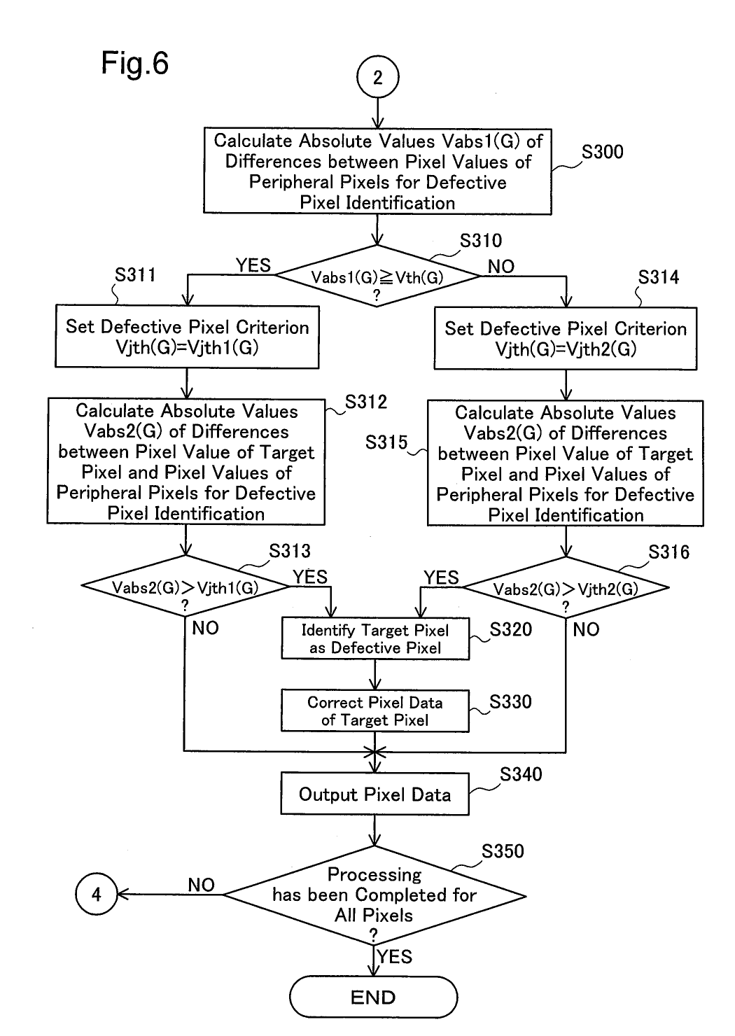

Upon identification of the color of the target pixel as green (G) at step S110 in the flowchart of FIG. 4, the processing flow proceeds to the flowchart of FIG. 6 after the specification of the peripheral pixels for defective pixel identification at step S130. The first computation module 20b calculates absolute values Vabs1(G) of respective differences between the pixel values of the peripheral pixels G1 to G12 for defective pixel identification specified with regard to the green (G) target pixel Gt as shown in FIG. 8(b) (step S300). The absolute values Vabs1(G) are used for subsequent determination of whether the target pixel Gt has a high potential for recognition as a defective pixel and are referred to by the defective pixel criterion setting module 20c to set a defective pixel criterion Vjth(G) for the green (G) target pixel Gt as explained later. The absolute values Vabs1(G) correspond to the first absolute values of the invention.

In this embodiment, the absolute values Vabs1(G) of the differences calculated by the first computation module 20b include the absolute value of the difference between the pixel values of the peripheral pixels G1 and G2 for defective pixel identification, the absolute value of the difference between the pixel values of the peripheral pixels G2 and G3 for defective pixel identification, the absolute value of the difference between the pixel values of the peripheral pixels G3 and G7 for defective pixel identification, the absolute value of the difference between the pixel values of the peripheral pixels G7 and G12 for defective pixel identification, the absolute value of the difference between the pixel values of the peripheral pixels G12 and G11 for defective pixel identification, the absolute value of the difference between the pixel values of the peripheral pixels G11 and G10 for defective pixel identification, the absolute value of the difference between the pixel values of the peripheral pixels G10 and G6 for defective pixel identification, the absolute value of the difference between the pixel values of the peripheral pixels G6 and G7 for defective pixel identification, the absolute value of the difference between the pixel values of the peripheral pixels G2 and G11 for defective pixel identification, the absolute value of the difference between the pixel values of the peripheral pixels G4 and G5 for defective pixel identification, the absolute value of the difference between the pixel values of the peripheral pixels G5 and G9 for defective pixel identification, the absolute value of the difference between the pixel values of the peripheral pixels G9 and G8 for defective pixel identification, the absolute value of the difference between the pixel values of the peripheral pixels G8 and G4 for defective pixel identification, the absolute value of the difference between the pixel values of the peripheral pixels G4 and G9 for defective pixel identification, and the absolute value of the difference between the pixel values of the peripheral pixels G5 and G8 for defective pixel identification (see FIG. 8(b)).

The defective pixel criterion setting module 20c determines whether at least one of the multiple calculated absolute values Vabs1(G) is not less than a threshold value Vth(G) of the green (G) target pixel Gt (step S310). This determines whether the target pixel Gt has a high potential for recognition as a defective pixel. When at least one of the multiple absolute values Vabs1(G) is not less than the threshold value Vth(G), it is determined that the target pixel Gt has a low potential for recognition as a defective pixel. When all the multiple absolute values Vabs1(G) are less than the threshold value Vth(G), on the other hand, it is determined that the target pixel Gt has a high potential for recognition as a defective pixel. As mentioned previously, such determination is based on the findings that relatively discrete pixel values of the peripheral pixels for defective pixel identification make the target pixel unlikely to be recognized as a defective pixel and that relatively close pixel values of the peripheral pixels for defective pixel identification make the target pixel likely to be recognized as a defective pixel. The threshold value Vth(G) corresponds to the preset threshold value of the invention.

When at least one of the multiple absolute values Vabs1(G) is not less than the threshold value Vth(G) (step S310: Yes), the defective pixel criterion setting module 20c sets a defective pixel criterion Vjth(G) for the green (G) target pixel Gt, which will be used in a later step by the defective pixel identification module 20e, to a preset threshold value Vjth1(G) (Vjth(G)=Vjth1(G)) (step S311). The threshold value Vjth1(G) corresponds to the first defective pixel criterion of the invention.

The second computation module 20d subsequently calculates absolute values Vabs2(G) of differences between the pixel value of the target pixel Gt and the pixel values of eight peripheral pixels G2, G4, G5, G6, G7, G8, G9, and G11 for defective pixel identification selected among the twelve peripheral pixels G1 to G12 for defective pixel identification specified with regard to the target pixel Gt (step S312). These eight peripheral pixels G2, G4, G5, G6, G7, G8, G9, and G11 are relatively close in distance from the target pixel Gt and are shown by right-down hatched rectangles in FIG. 8(b). The absolute values Vabs2(G) are used for subsequent identification of whether the target pixel Gt is a defective pixel by the defective pixel identification module 20e as explained later. The absolute values Vabs2(G) correspond to the second absolute values of the invention.

The defective pixel identification module 20e then determines whether all the multiple calculated absolute values Vabs2(G) are greater than the threshold value Vjth1(G) (step S313). When all the multiple absolute values Vabs2(G) are greater than the threshold value Vjth1(G) (step S313: Yes), the defective pixel identification module 20e identifies the target pixel Gt as a defective pixel (step S320).

The pixel data correction unit 30 then corrects the pixel data of the target pixel Gt (step S330). According to the concrete procedure of this embodiment, the pixel data correction unit 30 obtains the pixel values of the eight right-down hatched peripheral pixels G2, G4, G5, G6, G7, G8, G9, and G11 for defective pixel identification from the buffer 20ab, calculates an average of the obtained pixel values, and replaces the pixel value of the target pixel Gt by the calculated average to correct the pixel data of the pixel value Gt. The output unit 40 outputs the corrected pixel data (step S340). These eight peripheral pixels G2, G4, G5, G6, G7, G8, G9, and G11 are relatively close in distance from the target pixel Gt and are selected among the twelve peripheral pixels G1 to G12 for defective pixel identification specified with regard to the target pixel Gt as mentioned above.

When at least one of the multiple absolute values Vabs2(G) is not greater than the threshold value Vjth1(G) (step S313: No), on the other hand, the defective pixel identification module 20e identifies the target pixel Gt as no defective pixel. Without any correction of the pixel data of the target pixel Gt by the pixel data correction unit 30, the output unit 40 outputs the pixel data (step S340).

Upon completion of the processing and the output of pixel data with regard to all the pixels (step S350: yes), the processing flow terminates the defective pixel detection process and the pixel data correction process. Upon no completion of the processing and the output of pixel data with regard to all the pixels (step S350: No), on the other hand, the processing flow goes back to step S100 in the flowchart of FIG. 4 to detect a defective pixel with regard to a target pixel of a next object pixel block.

When all the multiple absolute values Vabs1(G) are less than the threshold value Vth(G) (step S310: No), the defective pixel criterion setting module 20c sets the defective pixel criterion Vjth(G) for the green (G) target pixel Gt, which will be used in a later step by the defective pixel identification module 20e, to a preset threshold value Vjth2(G) (Vjth(G)=Vjth2(G)) (step S314). The threshold value Vjth2(G) is smaller than the threshold value Vjth1(G). This sets the stricter criterion for identification of the target pixel Gt as a defective pixel, since the determination result of step S310 that all the multiple absolute values Vabs1(G) are less than the threshold value Vth(G) suggests that the target pixel Gt has a high potential for recognition as a defective pixel. The threshold value Vjth2(G) corresponds to the second defective pixel criterion of the invention.

In the same manner as the calculation at step S312, the second computation module 20d calculates the absolute values Vabs2(G) of the differences between the pixel value of the target pixel Gt and the pixel values of the eight right-down hatched peripheral pixels G2, G4, G5, G6, G7, G8, G9, and G11 for defective pixel identification (step S315). These eight peripheral pixels G2, G4, G5, G6, G7, G8, G9, and G11 are relatively close in distance from the target pixel Gt and are selected among the twelve peripheral pixels G1 to G12 for defective pixel identification specified with regard to the target pixel Gt as mentioned above.

The defective pixel identification module 20e then determines whether all the multiple calculated absolute values Vabs2(G) are greater than the threshold value Vjth2(G) (step S316). When all the multiple absolute values Vabs2(G) are greater than the threshold value Vjth2(G) (step S316: Yes), the defective pixel identification module 20e identifies the target pixel Gt as a defective pixel (step S320).

The pixel data correction unit 30 then corrects the pixel data of the target pixel Gt according to the procedure described above (step S330), and the output unit 40 outputs the corrected pixel data (step S340).

When at least one of the multiple absolute values Vabs2(G) is not greater than the threshold value Vjth2(G) (step S316: No), on the other hand, the defective pixel identification module 20e identifies the target pixel Gt as no defective pixel. Without any correction of the pixel data of the target pixel Gt by the pixel data correction unit 30, the output unit 40 outputs the pixel data (step S340).

Upon completion of the processing and the output of pixel data with regard to all the pixels (step S350: yes), the processing flow terminates the defective pixel detection process and the pixel data correction process. Upon no completion of the processing and the output of pixel data with regard to all the pixels (step S350: No), on the other hand, the processing flow goes back to step S100 in the flowchart of FIG. 4 to detect a defective pixel with regard to a target pixel of a next object pixel block.

### A2.3. Blue (B) Target Pixel

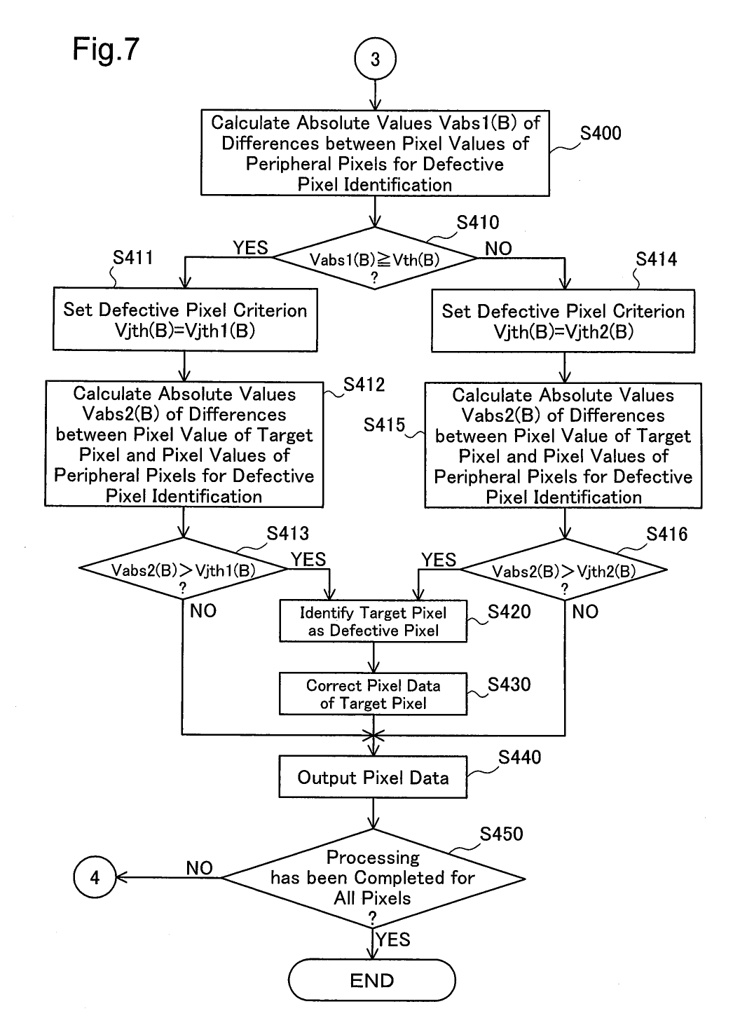

Upon identification of the color of the target pixel as blue (B) at step S110 in the flowchart of FIG. 4, the processing flow proceeds to the flowchart of FIG. 7 after the specification of the peripheral pixels for defective pixel identification at step S140. The first computation module 20b calculates absolute values Vabs1(B) of respective differences between the pixel values of the peripheral pixels B1 to B8 for defective pixel identification specified with regard to the blue (B) target pixel Bt as shown in FIG. 8(c) (step 400). The absolute values Vabs1(B) are used for subsequent determination of whether the target pixel Bt has a high potential for recognition as a defective pixel and are referred to by the defective pixel criterion setting module 20c to set a defective pixel criterion Vjth(B) for the blue (B) target pixel Bt as explained later. The absolute values Vabs1(B) correspond to the first absolute values of the invention.

In this embodiment, the absolute values Vabs1(B) of the differences calculated by the first computation module 20b include the absolute value of the difference between the pixel values of the peripheral pixels B1 and B2 for defective pixel identification, the absolute value of the difference between the pixel values of the peripheral pixels B2 and B3 for defective pixel identification, the absolute value of the difference between the pixel values of the peripheral pixels B3 and B5 for defective pixel identification, the absolute value of the difference between the pixel values of the peripheral pixels B5 and B8 for defective pixel identification, the absolute value of the difference between the pixel values of the peripheral pixels B8 and B7 for defective pixel identification, the absolute value of the difference between the pixel values of the peripheral pixels B7 and B6 for defective pixel identification, the absolute value of the difference between the pixel values of the peripheral pixels B6 and B4 for defective pixel identification, the absolute value of the difference between the pixel values of the peripheral pixels B4 and B5 for defective pixel identification, and the absolute value of the difference between the pixel values of the peripheral pixels B2 and B7 for defective pixel identification (see FIG. 8(c)).

The defective pixel criterion setting module 20c determines whether at least one of the multiple calculated absolute values Vabs1(B) is not less than a threshold value Vth(B) of the blue (B) target pixel Bt (step S410). This determines whether the target pixel Bt has a high potential for recognition as a defective pixel. When at least one of the multiple absolute values Vabs1(B) is not less than the threshold value Vth(B), it is determined that the target pixel Bt has a low potential for recognition as a defective pixel. When all the multiple absolute values Vabs1(B) are less than the threshold value Vth(B), on the other hand, it is determined that the target pixel Bt has a high potential for recognition as a defective pixel. As mentioned previously, such determination is based on the findings that relatively discrete pixel values of the peripheral pixels for defective pixel identification make the target pixel unlikely to be recognized as a defective pixel and that relatively close pixel values of the peripheral pixels for defective pixel identification make the target pixel likely to be recognized as a defective pixel. The threshold value Vth(B) corresponds to the preset threshold value of the invention.

When at least one of the multiple absolute values Vabs1(B) is not less than the threshold value Vth(B) (step S410: Yes), the defective pixel criterion setting module 20c sets a defective pixel criterion Vjth(B) for the blue (B) target pixel Bt, which will be used in a later step by the defective pixel identification module 20e, to a preset threshold value Vjth1(B) (Vjth(B)=Vjth1(B)) (step S411). The threshold value Vjth1(B) corresponds to the first defective pixel criterion of the invention.

The second computation module 20d subsequently calculates absolute values Vabs2(B) of differences between the pixel value of the target pixel Bt and the pixel values of the peripheral pixels B1 to B8 for defective pixel identification specified with regard to the target pixel Bt (step S412). The absolute values Vabs2(B) are used for subsequent identification of whether the target pixel Bt is a defective pixel by the defective pixel identification module 20e as explained later. The absolute values Vabs2(B) correspond to the second absolute values of the invention.

The defective pixel identification module 20e then determines whether all the multiple calculated absolute values Vabs2(B) are greater than the threshold value Vjth1(B) (step S413). When all the multiple absolute values Vabs2(B) are greater than the threshold value Vjth1(B) (step S413: Yes), the defective pixel identification module 20e identifies the target pixel Bt as a defective pixel (step S420).

The pixel data correction unit 30 then corrects the pixel data of the target pixel Bt (step S430). According to the concrete procedure of this embodiment, the pixel data correction unit 30 obtains the pixel values of the peripheral pixels B1 to B8 for defective pixel identification specified with regard to the target pixel Bt from the buffer 20ab, calculates an average of the obtained pixel values, and replaces the pixel value of the target pixel Bt by the calculated average to correct the pixel data of the pixel value Bt. The output unit 40 outputs the corrected pixel data (step S440).

When at least one of the multiple absolute values Vabs2(B) is not greater than the threshold value Vjth1(B) (step S413: No), on the other hand, the defective pixel identification module 20e identifies the target pixel Bt as no defective pixel. Without any correction of the pixel data of the target pixel Bt by the pixel data correction unit 30, the output unit 40 outputs the pixel data (step S440).

Upon completion of the processing and the output of pixel data with regard to all the pixels (step S450: yes), the processing flow terminates the defective pixel detection process and the pixel data correction process. Upon no completion of the processing and the output of pixel data with regard to all the pixels (step S450: No), on the other hand, the processing flow goes back to step S100 in the flowchart of FIG. 4 to detect a defective pixel with regard to a target pixel of a next object pixel block.

When all the multiple absolute values Vabs1(B) are less than the threshold value Vth(B) (step S410: No), the defective pixel criterion setting module 20c sets the defective pixel criterion Vjth(B) for the blue (B) target pixel Bt, which will be used in a later step by the defective pixel identification module 20e, to a preset threshold value Vjth2(B) (Vjth(B)=Vjth2(B)) (step S414). The threshold value Vjth2(B) is smaller than the threshold value Vjth1(B). This sets the stricter criterion for identification of the target pixel Bt as a defective pixel, since the determination result of step S410 that all the multiple absolute values Vabs1(B) are less than the threshold value Vth(B) suggests that the target pixel Bt has a high potential for recognition as a defective pixel. The threshold value Vjth2(B) corresponds to the second defective pixel criterion of the invention.

In the same manner as the calculation at step S412, the second computation module 20d calculates the absolute values Vabs2(B) of the differences between the pixel value of the target pixel Bt and the pixel values of the peripheral pixels B1 to B8 for defective pixel identification specified with regard to the target pixel Bt (step S415).

The defective pixel identification module 20e then determines whether all the multiple calculated absolute values Vabs2(B) are greater than the threshold value Vjth2(B) (step S416). When all the multiple absolute values Vabs2(B) are greater than the threshold value Vjth2(B) (step S416: Yes), the defective pixel identification module 20e identifies the target pixel Bt as a defective pixel (step S420).

The pixel data correction unit 30 then corrects the pixel data of the target pixel Bt according to the procedure described above (step S430), and the output unit 40 outputs the corrected pixel data (step S440).

When at least one of the multiple absolute values Vabs2(B) is not greater than the threshold value Vjth2(B) (step S416: No), on the other hand, the defective pixel identification module 20e identifies the target pixel Bt as no defective pixel. Without any correction of the pixel data of the target pixel Bt by the pixel data correction unit 30, the output unit 40 outputs the pixel data (step S440).

Upon completion of the processing and the output of pixel data with regard to all the pixels (step S450: yes), the processing flow terminates the defective pixel detection process and the pixel data correction process. Upon no completion of the processing and the output of pixel data with regard to all the pixels (step S450: No), on the other hand, the processing flow goes back to step S100 in the flowchart of FIG. 4 to detect a defective pixel with regard to a target pixel of a next object pixel block.

The red light, the green light, and the blue light have different visual sensitivities. Different values are accordingly set to the threshold values Vth(R), Vth(G), and Vth(B) for the red (R), green (B), and the blue (B) target pixels Rt, Bt, and Gt, as well as to the threshold values Vjth1(R), Vjth1(G), and Vjth1(B) and to the threshold values Vjth2(R), Vjth2(G), and Vjth2(B). Such setting enables the defective pixel identification module 20e to accurately identify whether each of the target pixels Rt, Bt, and Gt is a defective pixel according to the type (color) of the color filter.

The pixel data output by the output unit 40 at step S240, S340, or S440 is subjected to a required series of image processing performed by a hardware image processing circuit or by an image processing module of the software configuration. Typical examples of the image processing include white balance adjustment, gamma conversion, color correction, tone correction, contrast adjustment, and sharpness adjustment. The processed pixel data may be displayed on a display unit, such as a liquid crystal panel or may be subjected to data compression according to a preset format and recorded in a recording medium, such as a flash memory. The illustration and the detailed description of such processing are omitted in the specification hereof.

As described above, the imaging device 100 of the first embodiment is equipped with the defective pixel detector 20 to determine whether each of the target pixels Rt, Gt, and Bt has a high potential or a relatively low potential for recognition as a defective pixel in the imaging process. Based on the results of such determination, the defective pixel detector 20 can successively and accurately identify whether each of the target pixels Rt, Gt, and Bt is a defective pixel, regardless of the type of the defect as white defect or black defect. In the imaging device 100 of the first embodiment, in response to identification of each target pixel Rt, Gt, or Bt as a defective pixel by the defective pixel detector 20, the pixel data correction unit 30 corrects the pixel data of the target pixel Rt, Gt, or Bt identified as the defective pixel and the output unit 40 outputs the corrected pixel data.

### B. Second Embodiment

### B1. Structure of Imaging Device

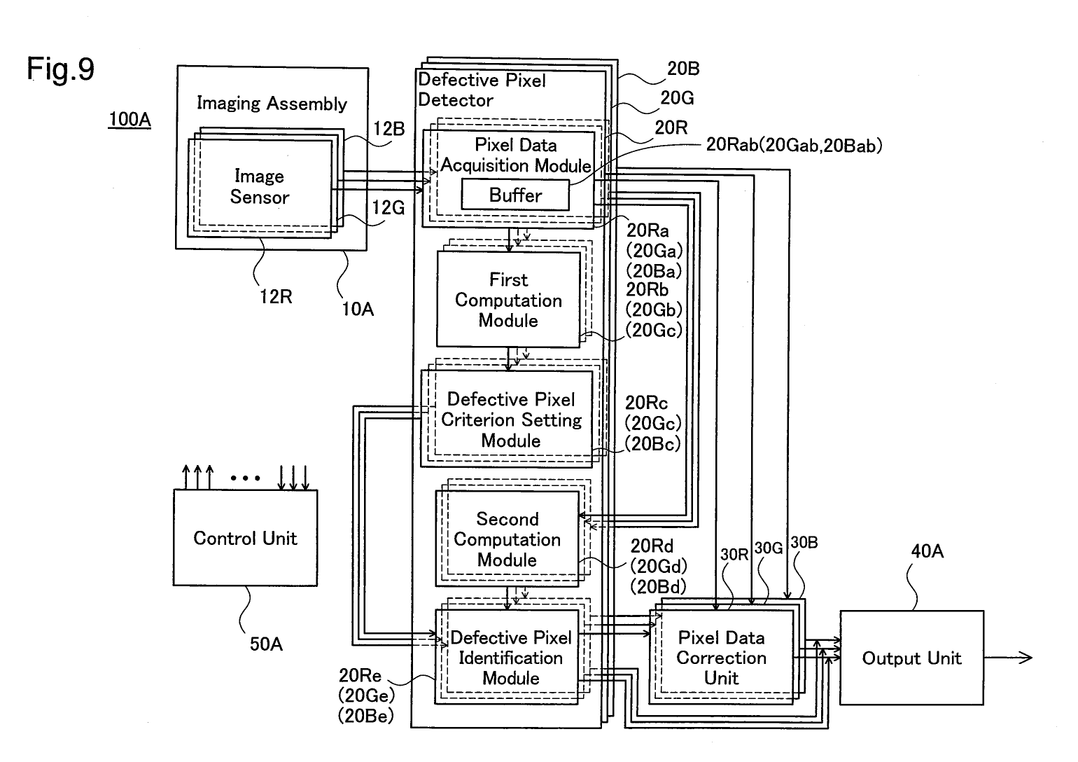

FIG. 9 schematically illustrates the structure of another imaging device 100A in a second embodiment of the invention. The imaging device 100A of the second embodiment has an imaging assembly 10A of a three-plate type including three image sensors 12R, 12G, and 12B, for example, CMOS sensors. The imaging assembly 10A has a light color separation optical system, in addition to the zoom lens, the focusing lens, and the aperture mechanism included in the imaging assembly 10 of the first embodiment. The light color separation optical system includes a prism arranged to separate the incident light entering via the zoom lens, the focusing lens, and the aperture mechanism into three color lights red (R), green (G), and blue (B). The image sensors 12R, 12G, and 12B respectively generate red (R) pixel data, green (G) pixel data, and blue (B) pixel data. Each of the image sensors 12R, 12G, and 12B has multiple light receiving elements arrayed in a matrix (not shown), as in the image sensor 12 of the first embodiment. In the imaging device 100A of the second embodiment, since the imaging assembly 10A has the light color separation optical system, no color filter is set on each of the light receiving elements in the respective image sensors 12R, 12G, and 12B.

The imaging device 100A has three defective pixel detectors 20R, 20G, and 20B and three pixel data correction units 30R, 30G, and 30B corresponding to the respective image sensors 12R, 12G, and 12B, and an output unit 40A. Like the imaging device 100 of the first embodiment, the imaging device 100A of the second embodiment successively detects defective pixels (white defects and black defects) among multiple pixels constituting a taken image, corrects pixel data of the detected defective pixels, and outputs the corrected pixel data. The defective pixel detectors 20R, 20G, and 20B, the pixel data correction units 30R, 30G, and 30B, and the output unit 40A are configured by the hardware in this embodiment, although some part of these constituents may be implemented by the software configuration. The imaging device 100A also includes a display unit constructed to display the taken image, for example, a liquid crystal panel, and a recorder unit constructed to store the taken image as pixel data in a recording medium, such as a flash memory, although not being specifically illustrated. The imaging device 100A further has a control unit 50A configured to include a CPU, a RAM, and a ROM and control the respective constituents of the imaging device 100A.

The defective pixel detector 20R includes a pixel data acquisition module 20Ra, a first computation module 20Rb, a defective pixel criterion setting module 20Rc, a second computation module 20Rd, and a defective pixel identification module 20Re. The defective pixel detector 20G includes a pixel data acquisition module 20Ga, a first computation module 20Gb, a defective pixel criterion setting module 20Gc, a second computation module 20Gd, and a defective pixel identification module 20Ge. The defective pixel detector 20B includes a pixel data acquisition module 20Ba, a first computation module 20Bb, a defective pixel criterion setting module 20Bc, a second computation module 20Bd, and a defective pixel identification module 20Be. The pixel data acquisition modules 20Ra, 20Ga, and 20Ba respectively have buffers 20Rab, 20Gab, and 20Bab.

The functions of the defective pixel detectors 20R, 20G, and 20B, the pixel data correction units 30R, 30G, and 30B, and the output unit 40A are substantially equivalent to the functions of the defective pixel detector 20, the pixel data correction unit 30, and the output unit 40 in the first embodiment. The defective pixel detectors 20R, 20G, and 20B correspond to the defective pixel detector of the invention.

### B2. Defective Pixel Detection Process and Pixel Data Correction Process

The processing flow of the defective pixel detection process and the pixel data correction process performed in the second embodiment is similar to the processing flow of the defective pixel detection process and the pixel data correction process performed in the first embodiment. The imaging device 100A of the second embodiment, however, includes the three defective pixel detectors 20R, 20G, and 20B and the three pixel data correction units 30R, 30G, and 30B corresponding to the respective image sensors 12R, 12G, and 12B. Unlike the processing flow of the first embodiment, the processing flow of the second embodiment does not perform the different series of processing with regard to the respective colors of the target pixels. The three defective pixel detectors 20R, 20G, and 20B and the three pixel data correction units 30R, 30G, and 30B simultaneously perform an identical series of processing.

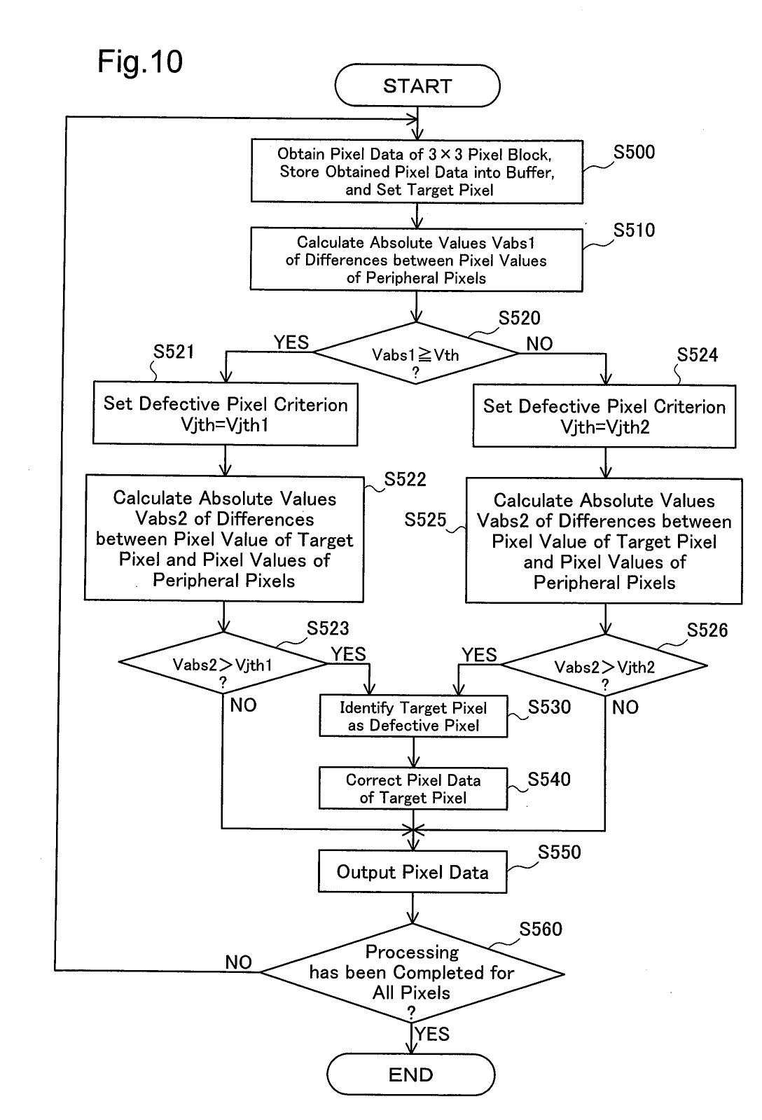

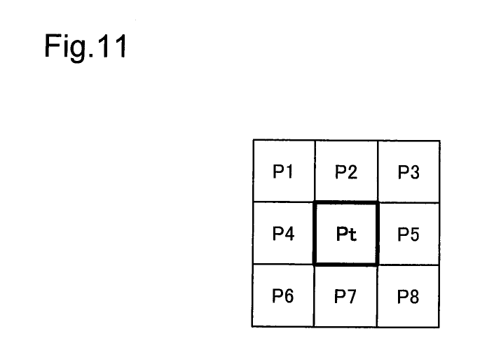

FIG. 10 is a flowchart showing the defective pixel detection process and the pixel data correction process performed in the second embodiment. FIG. 11 schematically shows an arrangement of pixels in a 3×3 pixel block. In this embodiment, a pixel located on the center of the pixel block and encircled by the thick line represents a target pixel Pt as an object of defective pixel detection. All surrounding pixels P1 to P8 located in the neighborhood of the target pixel Pt are specified as peripheral pixels for defective pixel identification. As mentioned above, the three defective pixel detectors 20R, 20G, and 20B have identical functions, and the three mage data correction units 30R, 30G, and 30B have identical functions. The description accordingly regards the defective pixel detection process and the pixel data correction process for only red (R) pixels, while the explanation is omitted with regard to the defective pixel detection process and the pixel data correction process for green (G) pixels and blue (B) pixels. The processing steps in the defective pixel detection process and the pixel data correction process of the second embodiment identical with those in the defective pixel detection process and the pixel data correction process of the first embodiment are not specifically explained here.

Referring to the flowchart of FIG. 10, the pixel data acquisition module 20Ra first obtains analog pixel data of each 3×3 pixel block as a current processing object out of analog pixel data output from respective light receiving elements of the image sensor 12R, performs analog-to-digital (A-D) conversion of the obtained analog pixel data, stores the A-D converted pixel data as pixel values of the respective pixels in the object pixel block into the buffer 20Rab, and sets a center pixel located on the center of the object pixel block as a target pixel Pt (step S500).

The subsequent series of processing of steps S510 to S560 is identical with the processing of steps S200 to S250 shown in the flowchart of FIG. 5.

In this embodiment, absolute values Vabs1 corresponding to the first absolute values of the invention calculated at step S510 in the flowchart of FIG. 10 include the absolute value of the difference between the pixel values of the peripheral pixels P1 and P2, the absolute value of the difference between the pixel values of the peripheral pixels P2 and P3, the absolute value of the difference between the pixel values of the peripheral pixels P3 and P5, the absolute value of the difference between the pixel values of the peripheral pixels P5 and P8, the absolute value of the difference between the pixel values of the peripheral pixels P8 and P7, the absolute value of the difference between the pixel values of the peripheral pixels P7 and P6, the absolute value of the difference between the pixel values of the peripheral pixels P6 and P4, the absolute value of the difference between the pixel values of the peripheral pixels P4 and P5, and the absolute value of the difference between the pixel values of the peripheral pixels P2 and P7 (see FIG. 11).

A fixed threshold value Vth corresponding to the preset threshold value of the invention is used at step S520 in FIG. 10 with regard to red (R), green (G), and blue (B). Different threshold values Vth may alternatively be used with regard to red (R), green (G), and blue (B), like the first embodiment.

A fixed threshold value Vjth1 corresponding to the first defective pixel criterion of the invention is set to a defective pixel criterion Vjth at step S521 in FIG. 10 with regard to red (R), green (G), and blue (B). Different threshold values Vjth1 may alternatively be set to the defective pixel criterion Vjth with regard to red (R), green (G), and blue (B), like the first embodiment.

A fixed threshold value Vjth2 corresponding to the second defective pixel criterion of the invention is set to the defective pixel criterion Vjth at step S524 in FIG. 10 with regard to red (R), green (G), and blue (B). Different threshold values Vjth2 may alternatively be set to the defective pixel criterion Vjth with regard to red (R), green (G), and blue (B), like the first embodiment.

As described above, the imaging device 100A of the second embodiment is equipped with the imaging assembly 10A including the three image sensors 12R, 12G, and 12B and with the three defective pixel detectors 20R, 20G, and 20B provided corresponding to these three image sensors 12R, 12G, and 12B. Each of the defective pixel detectors 20R, 20G, and 20B determines whether the target pixel Pt has a high potential or a relatively low potential for recognition as a defective pixel in the imaging process. Based on the results of such determination, the defective pixel detectors 20R, 20G, and 20B can successively and accurately identify whether each of the target pixels Pt is a defective pixel, regardless of the type of the defect as white defect or black defect. In the imaging device 100A of the second embodiment, in response to identification of the target pixel Pt as a defective pixel by the defective pixel detector 20R, 20G, or 20B, the corresponding pixel data correction unit 30R, 30G, or 30B corrects the pixel data of the target pixel Pt identified as the defective pixel and the output unit 40A outputs the corrected pixel data.

### C. Other Aspects

The first and the second embodiments discussed above are to be considered in all aspects as illustrative and not restrictive. There may be many modifications, changes, and alterations without departing from the scope or spirit of the main characteristics of the present invention. Some examples of possible modification are given below.

### C1. Modified Example 1

In the procedure of the first embodiment, the defective pixel criterion setting module 20c sets the defective pixel criterion Vjth(R) for the red (R) target pixel Rt to the threshold value Vjth1(R) when at least one of the multiple absolute values Vabs1(R) is not less than the preset threshold value Vth(R), while setting the defective pixel criterion Vjth(R) to the threshold value Vjth2(R) when all the multiple absolute values Vjth(R) are less than the preset threshold value Vth(R). This arrangement is, however, neither essential nor restrictive. In one modified procedure, the defective pixel criterion setting module 20c may set the defective pixel criterion Vjth(R) to the threshold value Vjth1(R) when all the multiple absolute values Vabs1(R) are not less than the preset threshold value Vth(R), while setting the defective pixel criterion Vjth(R) to the threshold value Vjth2(R) when at least one of the multiple absolute values Vjth(R) is less than the preset threshold value Vth(R). Such modification is also applicable to the green (G) target pixel Gt and the blue (B) target pixel Bt.

### C2. Modified Example 2

In the procedure of the first embodiment, the defective pixel identification module 20e identifies the red (R) target pixel Rt as a defective pixel when all the multiple absolute values Vabs2(R) are greater than the threshold value Vjth1(R), while identifying the target pixel Rt as non-defective pixel when at least one of the multiple absolute values Vabs2(R) is not greater than the threshold value Vjth1(R). This arrangement is, however, neither essential nor restrictive. In one modified procedure, the defective pixel identification module 20e may identify the target pixel Rt as a defective pixel when at least one of the multiple absolute values Vabs2(R) is greater than the threshold value Vjth1(R), while identifying the target pixel Rt as non-defective pixel when all the multiple absolute values Vabs2(R) are not greater than the threshold value Vjth1(R). Such modification is also applicable to the green (G) target pixel Gt and the blue (B) target pixel Bt.

### C3. Modified Example 3

In the first embodiment, the pixel data correction unit 30 calculates the simple average of the pixel data of the peripheral pixels for defective pixel identification specified with regard to the target pixel and replaces the pixel data of the target pixel by the calculated average to correct the pixel data of the target pixel. This arrangement is, however, neither essential nor restrictive. In one modification, the pixel data correction unit 30 may replace the pixel data of the target pixel by a weighted average of the pixel data of the peripheral pixels for defective pixel identification, instead of the simple average of the pixel data of the peripheral pixels for defective pixel identification. Such modification is also applicable to the second embodiment.

### C4. Modified Example 4

In the first embodiment, the pixel data acquisition module 20a obtains pixel data of a 5×5 pixel block. In the second embodiment, the three pixel data acquisition modules 20Ra, 20Ga, and 20Ba respectively obtain pixel data of 3×3 pixel blocks. This arrangement is, however, neither essential nor restrictive and may be modified arbitrarily to obtain pixel data of a target pixel and pixel data of surrounding pixels located in a neighborhood of the target pixel. For the high-speed execution of the defective pixel detection process and the pixel data correction process, the smallest possible number of pixel data obtained is preferable.

### C5. Modified Example 5

In the first embodiment, different values are set to the threshold value Vth(R) for the red (R) target pixel Rt, to the threshold value Vth(G) for the green (G) target pixel Gt, and to the threshold value Vth(B) for the blue (B) target pixel Bt. Such setting is, however, neither essential nor restrictive. One identical value may alternatively be set to all the threshold values Vth(R), Vth(G), and Vth(B).

In the first embodiment, different values are set to the threshold value Vjth1(R) for the red (R) target pixel Rt, to the threshold value Vjth1(G) for the green (G) target pixel Gt, and to the threshold value Vjth1(B) for the blue (B) target pixel Bt. Such setting is, however, neither essential nor restrictive. One identical value may alternatively be set to all the threshold values Vjth1(R), Vjth1(G), and Vjth1(B).

In the first embodiment, different values are set to the threshold value Vjth2(R) for the red (R) target pixel Rt, to the threshold value Vjth2(G) for the green (G) target pixel Gt, and to the threshold value Vjth2(B) for the blue (B) target pixel Bt. Such setting is, however, neither essential nor restrictive. One identical value may alternatively be set to all the threshold values Vjth2(R), Vjth2(G), and Vjth2(B).

### C6. Modified Example 6

In the first embodiment and the second embodiment described above, the threshold values Vth(R), Vth(G), and Vth(B), the threshold values Vjth1(R), Vjth1(G), and Vjth1(B), and the threshold values Vjth2(R), Vjth2(G), and Vjth2(B) are all fixed values. Such setting is, however, neither essential nor restrictive. These threshold values may alternatively be varied according to the magnitudes of the pixel values of the peripheral pixels for defective pixel identification. The larger pixel values of the peripheral pixels for defective pixel identification representing the higher luminance increase the potential for recognition of the target pixel as a black defect. The smaller pixel values of the peripheral pixels for defective pixel identification representing the lower luminance increase the potential for recognition of the target pixel as a white defect. In other words, the larger pixel values of the peripheral pixels for defective pixel identification representing the higher luminance decrease the potential for recognition of the target pixel as a white defect. The smaller pixel values of the peripheral pixels for defective pixel identification representing the lower luminance decrease the potential for recognition of the target pixel as a black defect.

One concrete procedure of varying the above threshold values according to the magnitudes of the pixel values of the peripheral pixels for defective pixel identification may set each of these threshold values based on a simple average or a weighted average of the pixel values of the peripheral pixels for defective pixel identification. In this case, there may be a linear or non-linear relation between each of the threshold values and the simple average or the weighted average of the pixel values of the peripheral pixels for defective pixel identification. Each of the threshold values may be calculated according to a predetermined operation based on this linear or non-linear relation. Each of the threshold values may otherwise be set with reference to a table recording the linear or non-linear relation between each of the threshold values and the simple average or the weighted average of the pixel values of the peripheral pixels for defective pixel identification.

### C7. Modified Example 7

The first embodiment adopts the CMOS sensor for the image sensor 12. This is, however, not restrictive. In another example, a CCD may be adopted for the image sensor 12. In this latter application, any of various types of CCDs may be used for the image sensor 12, for example, single-shot type (single-plate CCD), multi-shot type, scanner type, and 3CCD type. Such modification is also applicable to the second embodiment.

What is claimed is:

1. A defective pixel detector mounted on an imaging device and constructed to detect a defective pixel among multiple pixels constituting an image taken with the imaging device, the defective pixel detector comprising:
a pixel data acquisition module configured to successively obtain pixel data representing a pixel value of a target pixel set as an object of defective pixel detection and pixel data representing pixel values of plural surrounding peripheral pixels located in a neighborhood of the target pixel;
a first operation module configured to calculate absolute values of differences between pixel values of multiple specific peripheral pixels selected among the plural surrounding pixels, as first absolute values;
a defective pixel criterion setting module configured to set a defective pixel criterion, which is used in subsequent identification of whether the target pixel is a defective pixel, based on differences between the multiple first absolute values and a preset threshold value;
a second operation module configured to calculate absolute values of differences between the pixel value of the target pixel and the pixel values of the multiple specific peripheral pixels, as second absolute values; and
a defective pixel identification module configured to identify whether the target pixel is a defective pixel, based on the multiple second absolute values and the set defective pixel criterion.

2. The defective pixel detector in accordance with claim 1, wherein the defective pixel criterion setting module sets the defective pixel criterion to a first defective pixel criterion when the multiple first absolute values are respectively not less than the preset threshold value, while setting the defective pixel criterion to a second defective pixel criterion, which is smaller than the first defective pixel criterion, when the multiple first absolute values are respectively less than the preset threshold value.

3. The defective pixel detector in accordance with claim 2, wherein the defective pixel criterion setting module sets at least one of the first defective pixel criterion and the second defective pixel criterion, based on the pixel values of the multiple specific peripheral pixels.

4. The defective pixel detector in accordance with claim 1, wherein the defective pixel identification module identifies the target pixel as a defective pixel when the multiple second absolute values are respectively greater than the defective pixel criterion.

5. The defective pixel detector in accordance with claim 1, wherein the imaging device is equipped with an image sensor including multiple light receiving elements provided corresponding to the multiple pixels and arranged to respectively output pixel data representing pixel values of the corresponding pixels,
multiple different types of color filters designed to transmit different color lights are set in a predetermined arrangement on the multiple light receiving elements, and
the multiple specific peripheral pixels correspond to specific light receiving elements having a selected type of color filters identical with a color filter set on a light receiving element corresponding to the target pixel.

6. The defective pixel detector in accordance with claim 5, wherein the preset threshold value is set for each of the multiple different types of color filters.

7. The defective pixel detector in accordance with claim 5, wherein the defective pixel criterion is set for each of the multiple different types of color filters.

8. An imaging device, comprising:
an imaging assembly equipped with an image sensor including multiple light receiving elements provided corresponding to multiple pixels constituting a taken image and arranged to respectively output pixel data representing pixel values of the corresponding pixels;
a defective pixel detector configured to detect a defective pixel among the multiple pixels, based on the pixel data respectively output from the multiple light receiving elements; and
a pixel data correction unit configured to correct pixel data representing a pixel value of the detected defective pixel,
wherein the defective pixel detector is the defective pixel detector in accordance with any one of claims 1 through 7.

9. The imaging device in accordance with claim 8, wherein the pixel data correction unit replaces the pixel data of the detected defective pixel by an average of the pixel values of the multiple specific peripheral pixels.

10. A defective pixel detection method configured to detect a defective pixel among multiple pixels constituting an image taken with an imaging device, the defective pixel detection method comprising:
successively obtaining pixel data representing a pixel value of a target pixel set as an object of defective pixel detection and pixel data representing pixel values of plural surrounding peripheral pixels located in a neighborhood of the target pixel;
calculating absolute values of differences between pixel values of multiple specific peripheral pixels selected among the plural surrounding pixels, as first absolute values;
setting a defective pixel criterion, which is used in subsequent identification of whether the target pixel is a defective pixel, based on differences between the multiple first absolute values and a preset threshold value;
calculating absolute values of differences between the pixel value of the target pixel and the pixel values of the multiple specific peripheral pixels, as second absolute values; and
identifying whether the target pixel is a defective pixel, based on the multiple second absolute values and the set defective pixel criterion.
